(19) United States
(12) Patent Application Publication
(10) Pub. No.: US 2025/0134743 A1
(43) Pub. Date: May 1, 2025

(54) ADAPTIVE ROBOTIC HEAD SUPPORT

(71) Applicant: The University of Tulsa, Tulsa, OK (US)

(72) Inventors: Bradford Kerst, Tulsa, OK (US); Bryce Day, Pryor, OK (US); Joshua Schultz, Tulsa, OK (US)

(21) Appl. No.: 18/812,758

(22) Filed: Aug. 22, 2024

Related U.S. Application Data
(60) Provisional application No. 63/545,859, filed on Oct. 26, 2023.

(51) Int. Cl. A61G 13/12

(52) U.S. Cl. CPC A61G 13/121; A61G 13/1295; A61G 2203/30

(57) ABSTRACT

Methods and systems of supporting a patient's head wherein a head support is attached to the head. The head support is connected to an adjustment system, which is configured to move the head support. There is a processor is configured to receive the position signals from sensors, determine adjustments to be made to the head support, and send adjustment signals to the adjustment system so that the head support is adjusted in accordance with the determined adjustments.

### CROSS-REFERENCE TO RELATED APPLICATION

This application claims the benefit of U.S. Provisional Application 63/545,859 filed Oct. 26, 2023, which is hereby incorporated by reference.

### STATEMENT REGARDING FEDERALLY SPONSORED RESEARCH OR DEVELOPMENT

This invention was made with government support under Contract/Grant No. 1706428 awarded by the National Science Foundation. The government has certain rights in the invention.

### FIELD

The present invention relates generally to systems and methods for supporting a patient's head.

### BACKGROUND OF THE INVENTION

Patients with head drop need external support to keep the head up and to move it around. Such a head drop condition can be the result of neurological disease or can be the result of an accident or a non-degenerative disease.

For example, this condition is seen in a number of neurological diseases such as Amyotrophic Lateral Sclerosis (ALS), Primary Lateral Sclerosis (PLS), Parkinson's Disease (PD), and Cerebral Palsy (CP). Patients suffering from these diseases can have neck muscles that are not strong enough to bring the head back to the neutral configuration from a flexed position. Often, they use static neck braces to keep the head in the upright configuration. These braces are typically made of foam or plastic, and fix the head relative to the shoulders with support under the chin. These static braces constrain the head of the user to a single configuration and are typically not favored by patients as these apply pressure under the chin causing difficulty in swallowing, breathing, and speaking. In addition, these braces can potentially weaken neck muscles due to lack of use, which may cause the muscles to atrophy. Further, despite the fact that most patients have weakness in lifting their head, some have adequate strength to perform lateral motion and these braces prevent such lateral motion.

Additionally, some prior art braces suspended the head but did not prevent rotational movement. However, these braces tended to be passive; thus, still tended to allow atrophy of muscles. Also, the suspension support was typically a manual adjustment that required disengaging the head brace for its support.

These problems with prior braces can be even more of an issue where the head drop is the result of an accident or a non-degenerative disease. In these cases, the muscles have been weakened but may be in a state where they can be strengthened as opposed to further degenerating over time. However, as indicated above, the use of conventional head braces tends to contribute to muscle atrophy rather than support strengthening of the muscles and resolution of the head drop.

Accordingly, there is a need for assistive head-support technologies that allow use of the remaining muscle activity to potentially mitigate symptoms and perhaps even slow down neurological disease progression and/or support strengthening of the muscles where possible.

### SUMMARY OF THE INVENTION

Generally, this disclosure relates to methods and systems of supporting a patient's head. In accordance with this disclosure, a head support is attached to the head, typically by straps. The head support is connected to an adjustment system, which is configured to move the head support, and hence the head, in at least one degree of freedom, and preferably two to four degrees of freedom. For example, four degrees of freedom could be adjusting the head up/down, left/right, forward/back, and rotationally in a horizontal plane.

Generally, there will be a processor connected to the adjustment system and one or more sensors. The sensors can detect pressure applied by the head to the head support and/or detect the head position. The processor is configured to receive the position signals from the sensors, determine adjustments to be made to the head support, and send adjustment signals to the adjustment system so that the head support is adjusted in accordance with the determined adjustments.

For example, the method using the system can comprise first defining initial positioning information including information on an initial head position within a head support and a programmed setting for adjustment of the head support. Next, the head support is adjusted to the initial head position. Afterwards, the head position is monitored during use of the system during which current position data of current head position is generated. Based on the current position data, the head support is adjusted to meet the therapeutic and/or support needs of the patient.

### BRIEF DESCRIPTION OF THE DRAWINGS

The drawings included with this application illustrate certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

FIG. 1 is a schematic drawing depicting a system for supporting a patient's head in accordance with one embodiment. FIG. 1 includes the head support and adjustment system with multiple degrees of freedom as shown in FIG. 3.

FIG. 2 is an illustration of the head support and adjustment system providing for vertical adjustments for the patient's head.

FIG. 3 is a schematic illustration of a head support and adjustment system with additional degrees of freedom over that illustrated in FIG. 2.

FIG. 4 is a flow chart illustrating a method according to this disclosure.

FIG. 5 is a flow chart illustrating a further method according to this disclosure, which can be utilized with the method of FIG. 4.

### DETAILED DESCRIPTION OF THE INVENTION

The present disclosure may be understood more readily by reference to the following description, including the figures. For simplicity and clarity of illustration, where appropriate, reference numerals may be repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may have been exaggerated to better illustrate details and features of the present disclosure.

Broadly, this disclosure relates to methods and systems of supporting a patient's head. More specifically, this disclosure relates to therapeutic robotic head support, which adapts the amount of support provided in real-time based on user input to the device and/or sensors monitoring the patient. The initial height of the head of the head can be adjusted by a user, typically a qualified therapist, who helps the patient to be in an upright starting position. A motor will increase or decrease the amount of support based on sensor measurements of the position of the head and how much weight the patient is holding themselves. The system can automatically adjust the amount of support provided based on sensor data built into the system. Accordingly, in some applications, the patient's strength, mobility, and control may be improved by resisting movements to leave a neutral position and by supporting movements moving back to a neutral position.

Conventional technology can provide passive support with a supervisor manually adjusting the height to a single position that aims to be best on average. The system and method of this disclosure enable the user to adjust the position by pressing a button, moving a toggle switch, or similar, which activates a motor and adjusts the belt controlling the height to an optimal length in real-time based on current pose and/or therapeutic goals. In some embodiments, the height is controlled by a therapeutic program that automatically adjusts the height based on the current pose and/or therapeutic goals. As used herein, “user” refers to a person that is overseeing the use of the system such as a therapist, doctor, or other aide. While in some cases, the patient whose head is secured by the head support can also be the user, more typically, the user will be a separate person from the patient.

For example, in some embodiments, a head support is attached to the head of a patient, typically by straps. The head support is connected to an adjustment system, which is configured to move or adjust the head support, and hence the head, in at least one degree of freedom, and preferably two to four degrees of freedom. For example, typically one degree of freedom will be adjusting the head up/down, while four degrees of freedom could be adjusting the head up/down, left/right, forward/back and rotationally in a horizontal plane. Adjustment of the head support can be automated or as the result of user input.

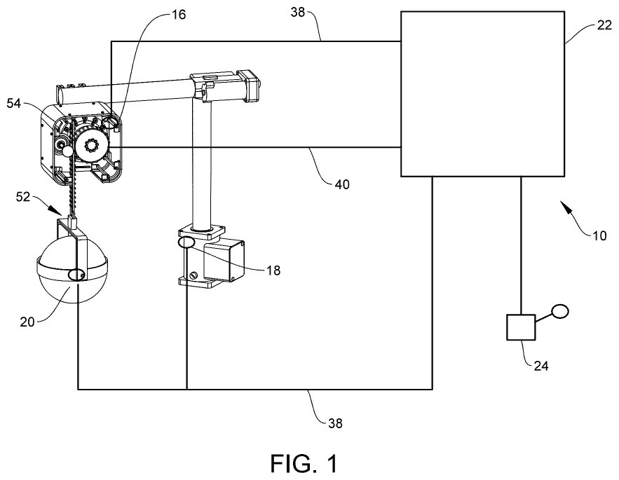

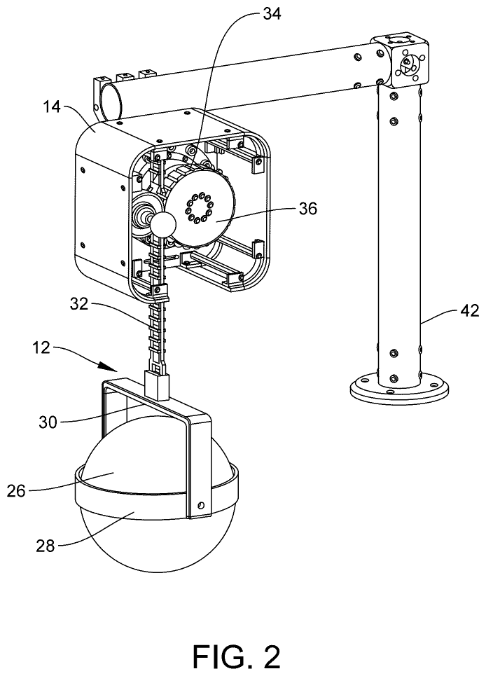

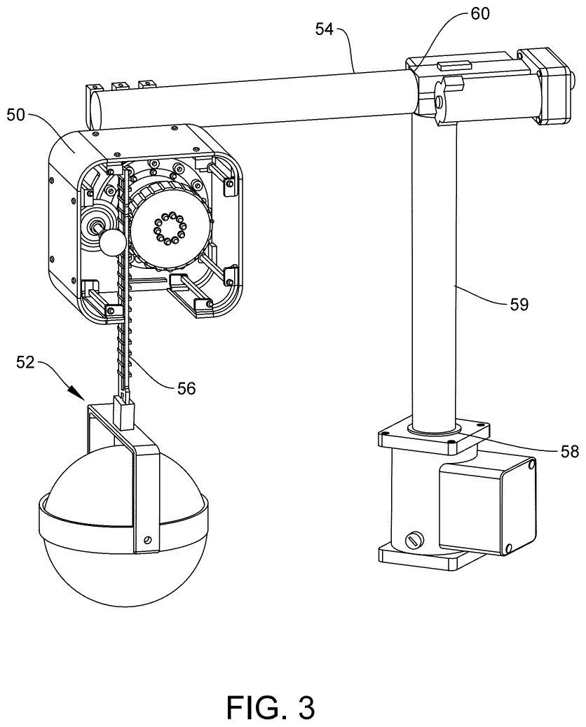

The system and method can be understood in more detail with reference to the figures. Referring specifically to FIGS. 1 to 3, elements of the system can be seen. FIGS. 1 and 3 illustrate a system providing multiple degrees of freedom and FIG. 2 illustrates a system providing one degree of freedom; that is, FIG. 2 provides head adjustment in only the vertical or up/down direction. As used herein, degree of freedom refers to the directions that the system can make adjustment. As will be understood below, the current system can make use of components that may allow the patient to move the patient's head (such as by using neck muscles) in other directions than those of adjustment; however, as used herein “degrees of freedom” or “degree of freedom” is referring to the directions that the system can move, adjust the head or otherwise provide force to the head.

System 10 of FIG. 1 is shown with the head support, and adjustment system of FIG. 3 but system 10 can be configured to use the head support and adjustment system of FIG. 2. That is, system 10 is illustrated as comprising head support 52 but could instead utilize support 12; system 10 is illustrated with adjustment system 54 but could instead utilize adjustment system 14. As illustrated, system 10 utilizes sensors 16, 18, and 20, processor 22, and manual adjuster 24.

The embodiment of FIG. 2 shows a head support and adjustment system that can be used in system 10. As best seen from FIG. 2, head support 12 comprises head strap 28 and brace 30, so that head support 12 can engage the head 26. Typically, the engagement is by straps 28 that sufficiently wrap the head to maintain head support 12 in functional contact with the head 26. Straps 28 are attached to brace 30, which is attached to flexible belt 32. Flexible belt 32 functionally engages adjustment system 14 so that adjustment system 14 can move head support 12 in the vertical direction-up or down. In this manner, the patient's head 26 can be supported. Additionally, belt 32 is flexible to allow the patient to rotate the patient's head under the patient's muscle power. For example, the belt can be flexible to allow 360-degree rotation (180 degrees to the right and 180 degrees to the left from the starting position, which will be understood to be greater than the range of motion of the human head) with little resistance when turning. Thus, the embodiment of FIG. 2 provides support for the head without restricting oblique rotation. However, in the embodiment of FIG. 2, the system cannot rotate the patient's head or apply force in the rotational direction.

Adjustment system 14 has a motor assembly 34 which interacts with belt 32 by means of a sprocketed drive wheel 36; thus, allowing precise adjustment of the support supplied to head support 12 without risk of slippage. For example, the drive wheel can have 20 to 50 teeth at a radius of from 30 to 60 mm, and the teeth can be approximately 2 to 5 mm in height, 5 to 10 mm in width, and 5 to 10 mm in radial length. For example, the drive wheel can have 24 teeth and a radius of 40 mm, and the teeth can be about 3 mm in height, 8 mm in width, and have a radial length of 8 mm.

Turning now to FIG. 3, another embodiment of the head support and adjustment system is illustrated. System 50 has multiple degrees of freedom. A head support 52 is functionally attached to adjustment system 54. Adjustment system 54 can be vertically adjusted by belt 56 similar to the description for FIG. 2, which provides for a vertical or up/down degree of freedom. Additionally, adjustment system 54 can provide additional degrees of freedom. For example, horizontal arm 60 can be rotationally mounted to a base 58 through vertical arm 59, and/or arm 60 can be rotationally mounted to vertical arm 59, to thus provide rotational movement to head support 52. Additionally, arm 60 can be rotated relative to vertical arm 59, or alternatively, arm 60 and vertical arm 59 can be rotated about base 58, to provide left/right movement to head support 52. Vertical arm 59 can also be telescoping to provide forward/backward movement to head support 22. For example, the telescoping forward/backward could be from 1 cm to 350 mm), more typically from 200 mm to 325 mm, such as about 300 mm. The telescoping can be accomplished in a continuous manner or can be at intervals, for example 1 mm to 20 mm intervals, more typically 5 mm to 15 mm intervals, such as 12 mm intervals. Adjustment system 54 has suitable motors (not shown) so that the processor can move the adjustment system through these additional degrees of freedom.

Returning now to FIG. 1, system 10 includes one or more sensors 16, 18, and 20. The sensors are configured to detect or measure parameters related to the head position and pressure. For example, motor sensor 16, which can be voltage or current usage data from the motor assembly 34, can provide information on the amount of pressure head 26 is placing head support 12. For example, motor sensor 16 can be a Hall effect sensor and suitable motors and microcontrollers are available from Celera Motion, Texas Instruments, and others. Additionally, a visual sensor, inclinometer, or inertial measurement unit 18 can be used to detect head orientation and/or positional information related to the head 26. Sensor 20 can detect the head position and pressure in relation to the movement of strap 28. Further, other sensors (not shown) can be utilized. For, example force or torque sensors (as known in the art) can be used on base 58 or arm 60 (FIG. 3) or can be used at brace 30 (FIG. 2). Thus, sensors 16, 18 and 20, alone or in combination with each other, and/or with other sensors provide information about the pressure applied by the head to the head support, or detect the head position, or both, and they produce a resulting position signal 38 from the detection.

System 10 can include one or more processors 22. Processor 22 is configured to receive the position signals 38. Based on the position signals the processor determine adjustments to be made to the head support. Processor 22 can use other information in addition to the signals to determine the adjustment, such as initial settings for the height of head support 12, and how the system should be adjusted over time to support the head, as further detailed below. Processor 22 is configured to send adjustment signals 40 to adjustment system 14 so that head support 12 is adjusted in accordance with the determined adjustments.

Additionally, a manual adjuster 24 can be functionally integrated with processor 22 so as to allow manual changes to the support provided by the user. For example, the manual adjuster can be a button, knob, or joystick to allow adjustments. Manual adjuster 24 can be used with or without programmed adjustments.

Typically, adjustment system 14 or 54 will be mounted by a frame 42 onto a wheelchair or similar mobile unit (not shown) so that the adjustment system is movable with the patient without placing strain on the patient, which can occur with shoulder-mounted head supports. Processor 22 can be mounted on frame 42 or on the mobile unit.

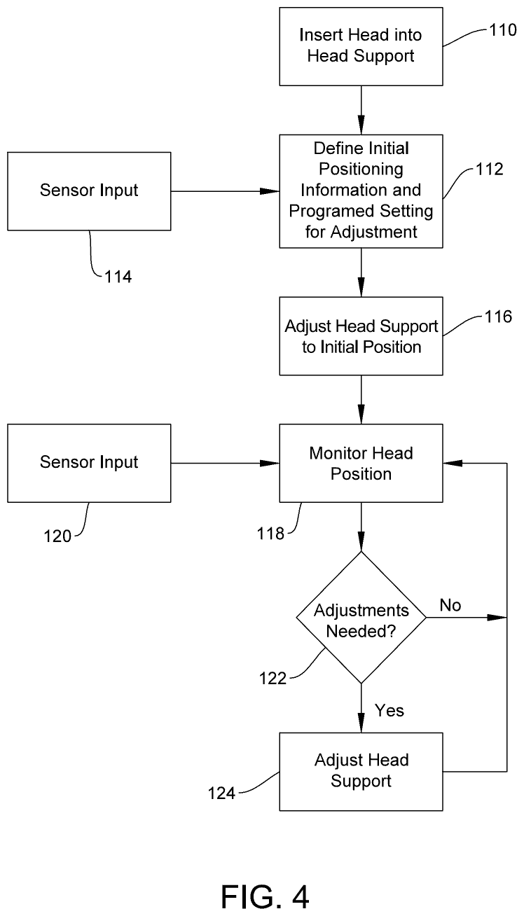

Turning now to FIG. 4, the method using the system will be described from which additional features of the system will also be realized. FIG. 4 is a flow chart of one embodiment of a method according to this disclosure. In the method, the head is inserted or fastened into the head support (step 110), and the initial position information is defined (step 112), which can include designating a programmed setting for adjustment. While these steps are illustrated sequentially, they may occur in any logical order. For example, if sensor input (step 114) is used to detect the initial head position or initial force of the head on the head support, then these will be entered after insertion of the head; however, historical data from prior use may be used as part of the initial positioning information, and it may be defined prior to the insertion of the head.

If a programmed setting is used, the selection of the programmed setting might occur before or after fastening the head support around the patient's head. The programmed settings can be for manual adjustment only (no automatic adjustment) by the user or therapist or can be a selection from therapeutic programs depending on the patient's condition and needs. For example, the programmed settings could include one or more of manual adjustment, stabilized adjustment and therapeutic adjustment. The manual adjustment only repositions the head support based on user input. The stabilized adjustment adjusts the head support to maintain the initial head position based on the current position data and the initial head position. The therapeutic adjustment adjusts the head support based on the current position data and a predetermined set of therapeutic goals. The therapeutic adjustment could also be adjusted based on perceived user intent, for instance lengthening the strap if the patient wishes to look in a particular direction, then providing forces to return the strap toward the preset neutral length to assist the patient with returning to a neutral pose once it is determined the patient no longer wishes to look this direction. The amount of assistance can be varied based on the patient's rehabilitation progress.

For example, the therapeutic goals can be to increase the support or assistance given over a period of time corresponding to continued use. Thus, more support or assistance is given as the patient's muscles fatigue over the period. For example, the therapeutic goals can be to adjust the resistance or assistance over time to transition the patient to need less assistance with head support as the use of the system and method progress. Thus, the therapeutic goal can be to increase the patient's cervical muscular strength by the therapeutic program adding resistance or to improve the patient's endurance and stability by aiding the user after they begin to fatigue from maintaining an upright posture on their own.

In some embodiments, the therapeutic program can distinguish voluntary movement from involuntary movement to provide resistance to involuntary movements and allow voluntary movements (purposeful movements). For example, if movement is detected, the system can be programmed to provide a small amount of additional resistance to the movement to determine if more force is applied by the patient for the movement (voluntary movement) or if the force does not increase (involuntary movement). If the system determines the movement is voluntary, the system then allows the movement. If the system determines the movement is involuntary, the system applies the force to correct for the movement.

After the initial positioning information is defined, the head support is adjusted to the initial position (step 116), if needed, and monitoring of the head position begins (step 118). Monitoring head position 118 generates position data of the current head position. The monitoring occurs during a period of time when a head is within the head support. During the period of time the processor receives the head position information from the sensors (step 120). The most recent of this information is the current position data. For example, the head position information can include receiving information on the current head position and the current amount of pressure the head is placing on the head support, and the current position data includes both the information on the current position and the current amount of pressure.

During monitoring, the processor can use the current and historical position data and the programmed setting and, in some cases, the initial positioning information to determine if adjustments are needed (step 122). When the processor determines that adjustments are needed, adjustment signals are sent to the head support system to adjust the head support accordingly (step 124). Depending on the head support system, the adjustment can be to provide more force or reduce the amount of force to the head support and/or to move the head support. The movement can be up/down only or may include one or more of up/down, left/right, forward/back, or rotationally in a horizontal plane. Typically, the steps of adjusting the head support include moving the head support in at least one of the directions.

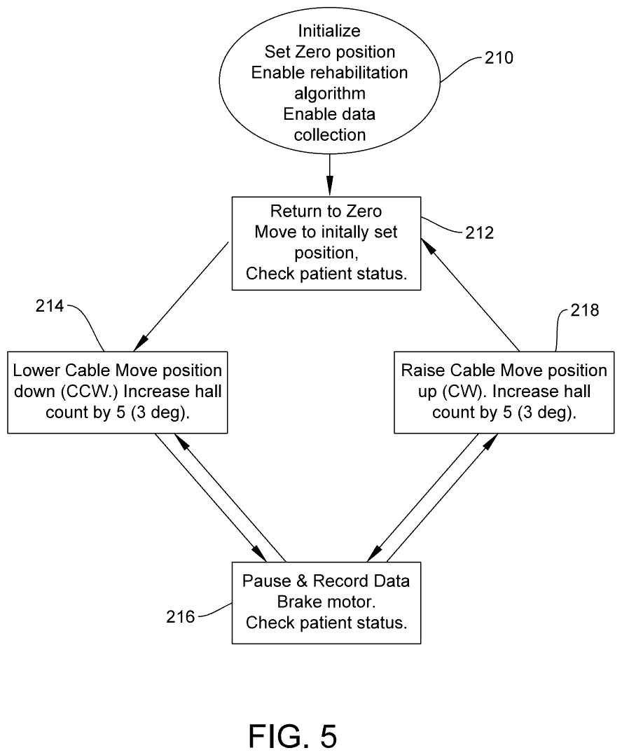

Turning now to FIG. 5, a description of a further method according to this disclosure is illustrated. In this method, a therapeutic program is used to enable rehabilitation. As in the method above, the patient's head is inserted or fastened into the head support, and the initial position information is defined (step 210), which can include designating a programmed setting for adjustment. The initial position information includes information on an initial head position within the head support and a threshold for head movement, and the programmed setting is for adjustment of the head support. If needed, the system is moved to the initial head set position, and the status of the patient is checked (step 212).

In the initial head set position, the head is provided with a predetermined amount of support by the system. In step 214, the head support is adjusted to provide less than the predetermined amount of support. During the process, the head position is monitored to generate current position data of current head position. In step 216, the system determines whether the movement is a controlled movement (controlled movement by the patient as opposed to an involuntary movement) or if the movement from the initial position is minimal (less than a threshold head movement amount). If either of these applies, the adjustment of the cable continues (step 214). For example, a controlled movement might be based on the patient moving his/her head within a predetermined amount of time, such as 3 seconds, 5 seconds or 7 seconds or 10 seconds, etc.

If the system determines that the head movement is more than the threshold head movement and is not a controlled movement in step 216, then the system proceeds to step 218 where the system adjust the cable to provide additional support such that the head movement is within the threshold value from the initial position. In some embodiments, the adjustment moves the head closer to the threshold value and then returns to step 216 to determine if the patient is now controlling movement or is self-adjusting to the threshold value. The system can alternate between steps 216 and 218 to slowly move the patient back to having a head position within the threshold value and provide the opportunity to allow the patient to support his/her head at least partially within the threshold value. If the patient cannot at least partially support his/her head within the threshold value, the system returns to the initial position at step 212.

As may be realized from the above, the system and method have numerous applications and advantages over the prior art. For example, the current system and method can provide for adjustments to be made as needed, that is within less than a second, less than 0.5 seconds and even in a range of 0.01 to 0.1 second of when a need for adjustment arises. Manual systems may not detect a need for adjustment for several minutes or longer, and even once the need is detected, they can take several seconds or even several minutes or longer before adjustments are made.

For example, the system and method cannot only be used to provide additional support for people with reduced head control, they can compensate for muscles getting tired during the day by increasing support as muscles fatigue. Additionally, the system and method can adjust the amount of support provided to transition between assistance and resistance based on the movements of the user. Further, therapeutic algorithms/programs can adjust the resistance or assistance over time to transition the patient to need less assistance with head support as the use of the system and method progress. For example, the system can be used to increase the patient's cervical muscular strength by adding resistance or to improve the patient's endurance and stability by aiding the user after they begin to fatigue from maintaining an upright posture on their own, which may increase patient endurance.

Prior head supports were limited in the increment of adjustments and were not well adapted to adjust the position of their users to consistently optimal positions. The motorized adjustments of the current system and method allow minute increments or continuous adjustments of the position as opposed to larger incremental adjustments. The system also allows easy optimization changes to the positions throughout the course of the use of the system and method. The current system and method can adjust the height of the strap for a faster, more precise position of the head to an upright posture than prior systems. Further, the current system and method allows the collection of data about the forces exerted on the head support, which can provide additional insight into the rehabilitation benefits of the user.

Example embodiments of the above-described method and system can be further understood by the followed numbered embodiments.

Embodiment 1: A method comprising:
defining initial positioning information including information on an initial head position within a head support and a programmed setting for adjustment of the head support;
adjusting the head support to the initial head position;
monitoring head position to generate current position data of current head position, wherein the monitoring occurs during a period of time that a head is within the head support; and
adjusting the head support during the period of time based on the current position data and the programmed setting.

Embodiment 2: The method of Embodiment 1, wherein a processor is used to monitor head position and to determine the adjustment to be in adjusting the head support based on the programmed setting.

Embodiment 3: The method of either embodiment 1 or embodiment 2, wherein the step of monitoring the head position includes receiving information on current head position and current amount of pressure the head is placing on the head support, and the current position data includes both the information on the current position and the current amount of pressure.

Embodiment 4: The method of any of Embodiments 1 to 3, wherein defining position information includes the steps of:
fastening the head support around the head; and
selecting the programmed setting for adjustment from a list including one or more of manual adjustment, stabilized adjustment, and therapeutic adjustment, wherein the manual adjustment only repositions the head support based on user input, the stabilized adjustment adjusts the head support to maintain the initial head position based on the current position data and the initial positioning information, and the therapeutic adjustment adjusts the head support based on the current position data and a predetermined set of therapeutic goals.

Embodiment 5: The method of any of the preceding embodiments, wherein the head support is configured to be moved in a direction including at least one of up/down, left/right, forward/back, or rotationally in a horizontal plane, and the steps of adjusting the head support include moving the head support in at least one of the directions.

Embodiment 6: The method of any of the preceding embodiments, wherein the step of monitoring head position includes distinguishing a voluntary movement from an involuntary movement.

Embodiment 7: A method comprising:
providing a processor operably connected to control the position of a head support and operably connected to sensors so that the processor receives information on the position and movement of a head within the head support;
defining initial positioning information and a programmed setting using the processor, wherein the positioning information includes information on an initial head position within the head support and a threshold for head movement and the programmed setting is for adjustment of the head support;
adjusting the head support to the initial head position wherein the head support provides a predetermined amount of support to the head;
monitoring head position to generate current position data of current head position, wherein the monitoring occurs during a period of time that a head is within the head support;
and adjusting the head support during the period of time based on the current position data and the programmed setting.

Embodiment 8: The method of Embodiment 7, wherein the step of adjusting the head support during the period of time comprises:
adjusting the head support to provide less than the predetermined amount of support;
determining whether there is a head movement after the step of adjusting the head support to provide less than the predetermined amount of support and whether the head movement is more than the threshold head movement;
when the head moves more than the threshold head movement, determine if movement is controlled movement; and
when the movement is not controlled movement, adjust the head support to increase support of the head.

Embodiment 9: The method of Embodiment 7 or 8, wherein the step of monitoring the head position includes receiving information on current head position and current amount of pressure the head is placing on the head support, and the current position data includes both the information on the current position and the current amount of pressure.

Embodiment 10: The method of any of Embodiments 7 to 9, wherein the head support is configured to be moved in a direction including at least one of up/down, left/right, forward/back, or rotationally in a horizontal plane, and the steps of adjusting the head support includes moving the head support in at least one of the directions.

Embodiment 11: A head supporting system, the system comprising:
a head support having one or more straps to engage the head;
an adjustment system connected to the head support to adjust the head support;
one or more sensors which detect pressure applied by the head to the head support, or detect the head position, or both, and which produce a position signal from the detection;
at least one processor configured to receive the position signals from the sensors, determine adjustments to be made to the head support, and send adjustment signals to the adjustment system so that the head support is adjusted in accordance with the determined adjustments.

Embodiment 12: The head support system of Embodiment 11, wherein the at least one processor is configured to carry out the following steps:
(a) receiving initial positioning information including information on an initial head position within the head support;
(b) monitoring head position to generate current position data of current head position based on the position signals, wherein the monitoring occurs during a period of time that a head is within the head support; and
(c) determining the adjustments to be made during the period of time based on the positions signals and a predetermined programmed setting.

Embodiment 13: The system of embodiment 12, wherein the predetermined programmed setting is a stabilized adjustment wherein the head support is adjusted to be maintained in the initial head position based on the current head position data and the initial head position.

Embodiment 14: The system of embodiment 12, wherein the predetermined programmed setting is a therapeutic adjustment, wherein the head support is adjusted based on the current head position data, and a predetermined set of therapeutic goals.

Embodiment 15: The system of embodiment 12 through 14, wherein monitoring the head position includes receiving information on current position of the head support and current amount of pressure the head is placing on the head support, and the current position data includes both the information on the current position and the current amount of pressure.

Embodiment 16: The system of any of embodiments 11 through 15, wherein the adjustment system is configured to move the head support in a direction including at least two of up/down, left/right, forward/back, or rotationally in a horizontal plane, and adjusting the head support includes moving the head support in at least one of the directions.

Embodiment 17: The system of any of embodiments 11 through 16, wherein the processor is configured to distinguish a voluntary movement from an involuntary movement.

While the methods are described in terms of “comprising,” “containing,” or “including” various components or steps, the methods also can “consist essentially of” or “consist of” the various components and steps. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent(s) or other documents that may be incorporated herein by reference, the definitions that are consistent with this specification should be adopted.

What is claimed is:

1. A method comprising:
defining initial positioning information including information on an initial head position within a head support and a programmed setting for adjustment of the head support;
adjusting the head support to the initial head position;
monitoring head position to generate current position data of current head position, wherein the monitoring occurs during a period of time that a head is within the head support; and
adjusting the head support during the period of time based on the current position data and the programmed setting.

2. The method of claim 1, wherein a processor is used to monitor head position and to determine the adjustment to be in adjusting the head support based on the programmed setting.

3. The method of claim 1, wherein the step of monitoring the head position includes receiving information on current head position and current amount of pressure the head is placing on the head support, and the current position data includes both the information on the current position and the current amount of pressure.

4. The method of claim 3, wherein defining position information includes the steps of:
fastening the head support around the head; and
selecting the programmed setting for adjustment from a list including one or more of manual adjustment, stabilized adjustment, and therapeutic adjustment, wherein the manual adjustment only repositions the head support based on user input, the stabilized adjustment adjusts the head support to maintain the initial head position based on the current position data and the initial position information, and the therapeutic adjustment adjusts the head support based on the current position data and a predetermined set of therapeutic goals.

5. The method of claim 4, wherein the head support is configured to be moved in a direction including at least one of up/down, left/right, forward/back, or rotationally in a horizontal plane, and the steps of adjusting the head support includes moving the head support in at least one of the directions.

6. The method of claim 5, wherein the step of monitoring head position includes distinguishing a voluntary movement from an involuntary movement.

7. The method of claim 6, wherein a processor is used to monitor head position and to determine the adjustment to be in adjusting the head support based on the programmed setting.

8. A method comprising:
providing a processor operably connected to control the position of a head support and operably connected to sensors so that the processor receives information on the position and movement of a head within the head support;
defining initial positioning information and a programmed setting using the processor, wherein the positioning information includes information on an initial head position within the head support and a threshold for head movement and the programmed setting is for adjustment of the head support;
adjusting the head support to the initial head position wherein the head support provides a predetermined amount of support to the head;
monitoring head position to generate current position data of current head position, wherein the monitoring occurs during a period of time that a head is within the head support; and
adjusting the head support during the period of time based on the current position data and the programmed setting.

9. The method of claim 8, wherein the step of adjusting the head support during the period of time comprises:
adjusting the head support to provide less than the predetermined amount of support;
determining whether there is a head movement after the step of adjusting the head support to provide less than the predetermined amount of support and whether the head movement is more than the threshold head movement;
when the head moves more than the threshold head movement, determine if movement is controlled movement; and
when the movement is not controlled movement, adjust the head support to increase support of the head.

10. The method of claim 9, wherein the step of monitoring the head position includes receiving information on current head position and current amount of pressure the head is placing on the head support, and the current position data includes both the information on the current position and the current amount of pressure.

11. The method of claim 10, wherein the head support is configured to be moved in a direction including at least one of up/down, left/right, forward/back, or rotationally in a horizontal plane, and the steps of adjusting the head support includes moving the head support in at least one of the directions.

12. A head supporting system, the system comprising:
a head support having one or more straps to engage the head;
an adjustment system connected to the head support to adjust the head support;
one or more sensors which detect pressure applied by the head to the head support, or detect the head position, or both, and which produce a position signal from the detection;
at least one processor configured to receive the position signals from the sensors, determine adjustments to be made to the head support, and send adjustment signals to the adjustment system so that the head support is adjusted in accordance with the determined adjustments.

13. The head support system of claim 12, wherein the at least one processor is configured to carry out the following steps:
(a) receiving initial positioning information including information on an initial head position within the head support;
(b) monitoring head position to generate current position data of current head position based on the position signals, wherein the monitoring occurs during a period of time that a head is within the head support; and
(c) determining the adjustments to be made during the period of time based on the position signals and a predetermined programmed setting.

14. The system of claim 13, wherein the monitoring the head position includes receiving information on current position of the head support and current amount of pressure the head is placing on the head support, and the current position data includes both the information on the current position and the current amount of pressure.

15. The system of claim 14, wherein the adjustment system is configured to move the head support in a direction including at least two of up/down, left/right, forward/back, or rotationally in a horizontal plane, and adjusting the head support includes moving the head support in at least one of the directions.

16. The system of claim 14, wherein the processor is configured to distinguish a voluntary movement from an involuntary movement.

17. The system of claim 16, wherein the predetermined programmed setting is a stabilized adjustment wherein the head support is adjusted to be maintained in the initial head position based on the current head position data and the initial head position.

18. The system of claim 16, wherein the predetermined programmed setting is a therapeutic adjustment, wherein the head support is adjusted based on the current head position data and a predetermined set of therapeutic goals.
